(19) United States
(12) Patent Application Publication
(10) Pub. No.: US 2015/0379208 A1
(43) Pub. Date: Dec. 31, 2015

(54) Database Maping Method and System

(71) Applicant: White Plume Technologies, LLC, Birmingham, AL (US)

(72) Inventor: Matthew Menendez, Mountain Brook, AL (US)

(21) Appl. No.: 14/728,809

(22) Filed: Jun. 2, 2015

Related U.S. Application Data
(60) Provisional application No. 62/019,196, filed on Jun. 30, 2014.

(51) Int. Cl. G06F 19/00

(52) U.S. Cl. CPC G06F 19/322

(57) ABSTRACT

A method and system for mapping and displaying to a user database entries from a first database to a second database are disclosed herein. In particular, ICD-10 medical codes are mapped to ICD-9 medical codes and displayed to a user in a format that reduces the number of codes presented and presents only those codes likely to be used. The codes may be categorized according to a customized selection of definitional parameters.

### CROSS-REFERENCE TO RELATED APPLICATIONS

This application claims priority to and benefit of filing of U.S. App. No. 62/019,196 filed on Jun. 30, 2014, and which is currently pending.

### FIELD OF INVENTION

The invention relates generally to mapping and display of information maintained in a computerized database.

### BACKGROUND OF INVENTION

Computer databases contain massive amounts of information in an ordered, logical fashion. While the organization of a single database can provide significant advantages, each database is created and ordered on the basis of a logical rules. Changing such logical rules, or including new information to be ordered within the database, can result in significant changes to the database structure and greatly increase the number of entries and types of information that can be considered within the database. This can result in new databases having different organizing principles. In order to transfer information from one database to another, a method for correlating one or more entries in the first database to one or more entries in the second database is necessary.

For example, in response to new federal mandates, hospitals, health systems and physician practices are transitioning their patient diagnosis and procedure codes from one coding system to another. The current coding system, known as ICD-9, has approximately 16,000 codes organized on the basis of the system and disease type. The new coding system, ICD-10, has over 69,000 diagnosis codes, which is more than four times as many codes. The substantially increased number of codes is due in part to more specific diagnosis laterality (e.g., “right knee” or “left knee,” as opposed to “knee”); more specific diagnoses of individual body parts (e.g., the code for fractured radius and ulna is split into two codes, one for the radius and one for the ulna); and the inclusion of a representation of the episode of care (e.g., whether the treatment is the first or initial treatment, a later treatment, or was undertaken for a specific purpose). In addition, in order to accommodate a translation of medical codes entered under ICD-9 to ICD-10, codes that are unlikely to have much, if any, clinical relevance are also included in ICD-10. For example, in order to translate the ICD-9 code for a diagnosis involving an unspecified “knee” in ICD-9, ICD-10 has codes relating to a “knee, unspecified,” in addition to “right knee” and “left knee.” Because ICD-9 codes do not specify which knee is injured, the unspecified option must be included in ICD-10. While this allows the unidentified knee diagnosed in the ICD-9 database to be translated to the ICD-10 database, it is not envisioned that a person coding the same diagnosis in ICD-10 for a new entry will not specify the knee at the time of diagnosis.

Although matters such as the specified body part or the episode of care are now required for entering ICD-10 codes, a person having an understanding of ICD-9 codes will find it helpful to refer to any ICD-10 code that may apply, or be “mapped to,” an ICD-9 code. However, as shown above, this may result in a large number of irrelevant or unnecessary codes being displayed, such as codes for “unspecified” anatomical locations, unspecified types of diseases, injuries or fractures, or episodes of care that are not relevant to the particular coding instance. As a result, hundreds or even thousands of codes in ICD-10 may be mapped to a single ICD-9 code (e.g, the ICD-9 code for Malunion of Fracture, code has over 2,500 potential ICD-10 code connections), yet only a handful may be actually relevant or need to be displayed to the user selecting the codes.

There are various ways that list of potential ICD-10 codes could be displayed to a user. For example, a user could begin entering keywords into a search field (e.g., “fracture, right, ulna”) and as the user enters the keywords, a list of corresponding codes could be displayed below the search field, in a manner similar to many online search engines. This approach has a number of drawbacks. First, it depends upon the accuracy and order of terms entered by the user. For some diagnoses, hundreds or thousands of ICD-10 codes and descriptions would be displayed, many of which are almost the same and only differ by a few letters. This makes it difficult to discriminate amongst the codes and select the correct one. Further, the desired code may be towards the bottom of the result list or even off the screen, depending on which keywords the user enters. Thus, the user might have to scroll through a large list and then discriminate between entries that appear almost the same. Another approach might be a “drill-down” display and selection method, where a user begins with a more general list of categories, with each selection bringing up a list of additional, narrower categories until a manageable list of relevant ICD-10 codes is displayed. Because of the relative complexity and number of codes in the ICD-10 database, this approach could require numerous selections (clicks) by the user to drill down to the final list of codes. This approach therefore can be tedious and time consuming.

Therefore, a process is needed for intuitively and quickly selecting the most relevant ICD-10 codes applicable to a particular ICD-9 code. This process may also be used in conjunction with mapping other types of databases where a second database includes significantly more entries than an earlier database.

### SUMMARY OF INVENTION

In some aspects, the invention relates to a method of displaying ICD-10 code information to a user for facilitating a selection by said user of a particular ICD-10 code applicable to medical care provided to a patient, having the steps of displaying a set of ICD-9 codes; receiving from the user a selection of one ICD-9 code from said ICD-9 code set; associating said selected ICD-9 code with a set of ICD-10 codes, each code of said ICD-10 code set being defined by at least two definitional parameters; displaying a set of the first definitional parameters on a first axis and a set of the second definitional parameter along a second axis; and receiving from a user a selection of each definitional parameter thereby defining a particular ICD-10 code.

In other respects, the invention relates to a method for creating a relevant list of applicable medical code entries in a second database that may apply to a particular patient, the applicable medical code entries each corresponding to a medical code entry in a first database, where the second database has more code entries than the first database, having the steps of identifying at least one medical code entry in the second database to which the medical code entry in the first database maps, the medical code entries in the second database forming a forward map list; identifying each medical code entry in the second database that backward maps to the medical code entry in the first database, the medical code entries in the second database forming a backward map list; combining the forward map list and the backward map list to form a combined list; identifying each code appearing in the combined list; removing clinically unlikely codes; and removing codes having unspecified times of care.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 depicts a process flow chart for identifying related codes in a mapping process, according to one embodiment disclosed here.

FIG. 2 depicts a process flow chart for processing codes according to risk, according to one embodiment disclosed here.

FIG. 3 depicts a table of related codes for displaying to a user, according to one embodiment disclosed here.

FIG. 4 depicts the removal of various scenarios' on the basis of likelihood of application or relevance, according to one embodiment disclosed here.

FIG. 5 depicts a table produced following the process of FIG. 4, according to one embodiment disclosed here.

FIG. 6 depicts a table showing the removal of clinically unlikely codes, according to one embodiment disclosed here.

FIG. 7 depicts a final table display after all parsing and removal of other unlikely options, according to one embodiment disclosed here.

### DETAILED DESCRIPTION

The term “about” as used herein refers to a value that may vary within the range of expected error inherent in typical measurement techniques known in the art.

The term “storage device” as used herein refers to a machine-readable device that retains data that can be read by mechanical, optical, or electronic means, for example by a computer. Such devices are sometimes referred to as “memory,” although as used herein a machine-readable data storage device cannot comprise a human mind in whole or in part, including human memory. A storage device may be classified as primary, secondary, tertiary, or off-line storage. Examples of a storage device that is primary storage include the register of a central processing unit, the cache of a central processing unit, and random-access memory (RAM) that is accessible to a central processing unit via a memory bus (generally comprising an address bus and a data bus). Primary storage is generally volatile memory, which has the advantage of being rapidly accessible. A storage device that is secondary storage is not directly accessible to the central processing unit, but is accessible to the central processing unit via an input/output channel. Examples of a storage device that is secondary storage include a mass storage device, such as a magnetic hard disk, an optical disk, a drum drive, flash memory, a floppy disk, a magnetic tape, an optical tape, a paper tape, and a plurality of punch cards. A storage device that is tertiary storage is not connected to the central processing unit until it is needed, generally accessed robotically. Examples of a storage device that is tertiary storage may be any storage device that is suitable for secondary storage, but configured such that it is not constantly connected to the central processing unit. A storage device that is off-line storage is not connected to the central processing unit, and does not become so connected without human intervention. Examples of a storage device that is off-line storage may be any storage device that is suitable for secondary storage, but configured such that it is not constantly connected to the central processing unit, and does not become so connected without human intervention. Secondary, tertiary, and offline storage are generally non-volatile, which has the advantage of requiring no source of electrical current to maintain the recorded information.

A storage device cannot be construed to be a mere signal, although information may be communicated to and from a storage device via a signal.

The term “telecommunications network” as used herein refers to a network capable of transferring information spatially by conducting signals, such as but not limited to electrical or optical signals. The network itself cannot be construed to be a mere signal. The “optical” signal need not comprise radiation in an optically visible wavelength, and may be in any suitable wavelength. The network may be a packet-switched network (such as a local area network or the Internet) or a circuit-switched network (such as some telephone networks or the global system for mobile communications (GSM)). Information sent via a packet-switched network may be for example electronic mail, an SMS text message, and a digital file sent via file transfer protocol (FTP). Information sent via a circuit-switched network may be for example a voice mail message, a facsimile message, an SMS text message, or a digital file.

The term “processor” or “central processing unit” (CPU) as used herein refers to a software execution device capable of executing a sequence of instructions (“program”). The CPU comprises an arithmetic logic unit, and may further comprise one or both of a register and cache memory.

The term “variable” as used herein refers to a symbolic name corresponding to a value stored at a given memory address on a data storage device (although this address may change). The value may represent information of many types, such as integers, real numbers, Boolean values, characters, and strings, as is understood in the art. As used herein the value of a variable is stored at least intermittently in a data storage device, and shall not be construed to refer to information only stored in a human mind. Any recitation of a variable implicitly requires the use of a data storage device.

The term “machine-readable format” as used herein refers to a medium of storing information that is configured to be read by a machine. Such formats include magnetic media, optical media, and paper media (punch cards, paper tape, etc.). Printed writing in a human language, if not intended or configured to be read by a machine, is not considered a machine readable format. In no case shall a human mind be construed as “machine readable format.”

The term “database” as used herein refers to an organized data structure comprising a plurality of records stored in machine-readable format.

In general terms, the process and systems disclosed are directed to a method of mapping entries in a small database to entries in a large database. In other aspects, the process and systems are also directed to identifying entries in the large database that are more likely to be used by a data entrant when converting an entry using the small database to an entry using the large database. In still other aspects, the processes and systems are directed to sorting and displaying preferred entries in the large database to the data entrant in an intuitive manner. The processes and systems have particular relevance with respect to the mapping and display of medical diagnosis and treatment codes from the ICD-9 database to the ICD-10 database, and these will be referred to specifically in this disclosure to describe the concepts, processes, and systems applicable to more general database applications. There are 16,000 ICD-9 codes, but over 69,000 ICD-10 codes. Not only do the ICD-10 codes include numerous additional descriptions of the location or type of diagnosis or treatment, but they also code information concerning the timing of the diagnosis or treatment (sometimes called the characteristic of “episode of care”). While almost half of the ICD-9 codes have only a single ICD-10 analog, the rest have multiple analogs, and some have hundreds, or even thousands, of potential conversions. The process and systems set forth herein are particularly suited for analyzing, evaluating, and displaying the analogous ICD-10 codes in an intuitive way.

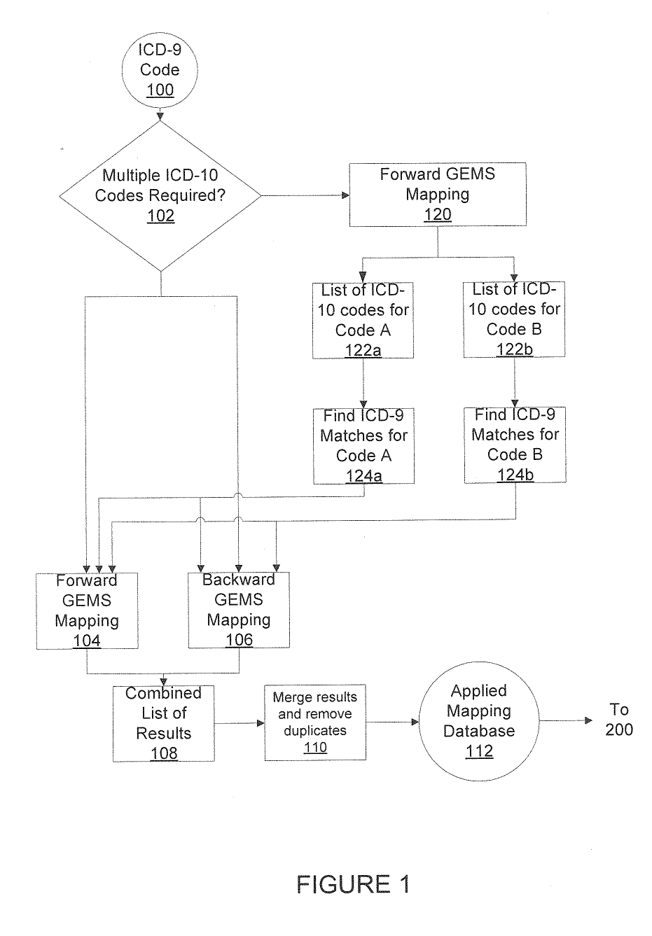

FIG. 1 depicts a process flow chart for identifying the first part of a mapping process as disclosed herein. In step 100, an ICD-9 code is identified for determining appropriate corresponding ICD-10 codes. In the simple case, a diagnosis or treatment described by an ICD-9 code may be described by one of multiple ICD-10 codes. (For example, the ICD-9 code describing “congestive heart failure” can be described one of a number of ICD-10 codes, but only a single ICD-10 code is necessary for fully describing the diagnosis or treatment.) For these situations, a list of potentially relevant ICD-10 codes may be identified using forward and backward mapping tools. Single-entry-to-single-entry forward and backward mapping tools called General Equivalence Mappings (GEMS) have been released by the Centers for Medicare and Medicaid Services and are freely available at http://www.ems.gov/Medicare/Coding/ICD10/2014-ICD-10-CM-and-GEMs.html. For the forward mapping GEM, an ICD-9 code is entered, and one or more ICD-10 codes are provided in response. Likewise for the backward mapping GEM, a single ICD-10 code is entered and a corresponding ICD-9 code is provided. Because ICD-10 has substantially more entries, the backward mapping GEM will output the same ICD-9 code for multiple ICD-10 codes. A reverse lookup of the ICD-10 codes that each map to the same identified ICD-9 code can identify the unique ICD-10 codes that are analogous to that ICD-9 code. By collecting all such ICD-10 codes, a “backward map” can be created that identifies the complete list of ICD-10 codes that a single ICD-9 code may be related or analogous to. This may be achieved by a software routine conducting the reverse lookup.

Although the GEMs provide one set of mappings between ICD-9 and ICD-10 codes, other mappings may also be created. For example, particular physicians, practices, coders, or other entities may have specific translation guidelines between a particular ICD-9 code and various ICD-10 codes. For this purpose, custom maps or scenarios may be created for those specific guidelines. Alternatively, certain common translations that always occur for a given ICD-9 code, no matter what ICD-10 codes may map back to that ICD-9 code, may be included as custom scenarios to avoid having to further parse, sort, and remove codes below. Similarly, if there are a particular subset of ICD-10 codes that would always be used, that can be identified as a custom map or scenario as well, and used in place of the GEMs for forward and backward mapping.

It is possible in some scenarios, discussed below, that multiple ICD-10 codes may be required to represent a single ICD-9 code. These may be found in the GEMs that are publicly available. This determination is made at step 102. Assuming that the ICD-9 code can be represented by a single ICD-10 code, the process continues to steps 104 and 106.

In step 104, a list of ICD-10 codes that are output by entering the ICD-9 code into the forward mapping GEM is produced. In step 106, the list of all ICD-10 codes that result in, or can be backwards mapped to, the identified ICD-9 code are obtained. These two lists are combined in step 108, and duplicate ICD-10 entries are removed in step 110. The result is a list of all unique ICD-10 codes that map to a single ICD-9 code.

The above process describes the simple case where a single ICD-10 code is sufficient to identify the documentation concepts contained within the ICD-9 code. However, as noted, in some cases, multiple ICD-10 codes are required to enter the same documentation concepts as an ICD-9 code. For example, in ICD-9, code 813.44 identifies a “closed fracture of lower end of radius with ulna.” However, in ICD-10, two codes are required to describe the same diagnosis. One code identifies the type and anatomical location of the fracture in the radial bone, the laterality (e.g., right radial bone or left radial bone), and the episode of care (for example, the code may be S52.511A for a “displaced fracture of right radial styloid process, initial encounter for closed fracture”). Similarly, the second code identifies the type and anatomical location of the fracture, the laterality, and the episode of care for the ulna (for example, the code may be S52.611A for a “displaced fracture of right ulna styloid process, initial encounter for closed fracture”). As a result, the user must enter a combination of two ICD-10 codes to accurately code the fracture of both bones in the forearm.

In order to address this situation, after the step 100 of identifying the ICD-9 code, it is first determined whether multiple sets of ICD-10 codes are required for mapping the ICD-9 code in step 102. In the example above, the two sets of ICD-10 codes would relate to radial fractures and ulnar fractures, respectively. Then, in step 120, the ICD-10 codes are identified using Forward GEMS mapping and separated into multiple lists, one for each ICD-10 code, as shown in step 122a and 122b. For each ICD-10 code that has been identified for referring to the original ICD-9 code, a substitute ICD-9 code is identified in steps 124a and 124b that may refer to the specific ICD-10 codes. For example, ICD-10 code S52.509A refers to an “unspecified fracture of the lower end of unspecified radius, initial encounter for closed fracture.” There is a matching ICD-9 code 813.42 for a “closed fracture of lower end of radius.” Note that the substitute code 813.42 differs slightly from 813.44, the original ICD-9 code in the example, because 814.44 includes the fractured ulna. A similar process occurs for the ulna ICD-10 codes, resulting in substitute ICD-9 code 813.43 describing a “closed fracture of lower end of ulna” being selected.

Once multiple substitute ICD-9 codes are selected to stand in for the original single ICD-9 code, the process continues as above for each individual substitute ICD-9 code. In step 104, the list of all ICD-10 codes that result in the identified substitute ICD-9 code through backward mapping are obtained. These two lists are combined in step 106, and duplicate ICD-10 entries are removed in step 108. The result is a list of all unique ICD-10 codes that map to a single substitute ICD-9 code. For purposes of preparing the applied maps that follow, the list of unique ICD-10 codes that map to each substitute ICD-9 code are maintained independently of each other.

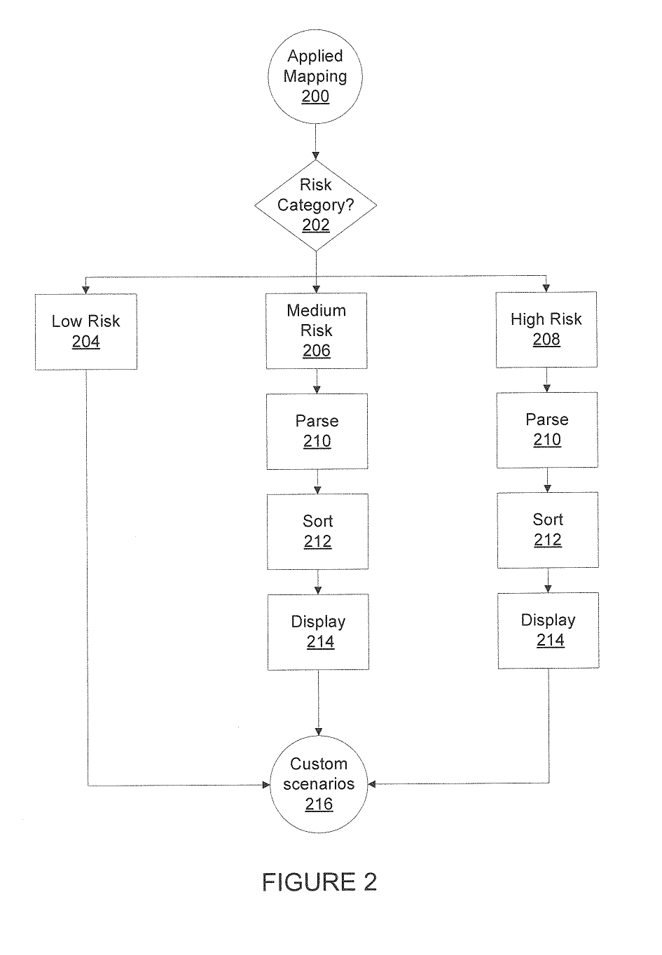

Once the list of ICD-10 codes is obtained, an applied mapping process is used to present the most relevant ICD-10 codes to the medical coder. FIG. 2 depicts a process flow chart for the first part of the applied mapping process. In step 202, the ICD-9 code is determined to be either a low-, moderate-, or high-risk code. Risk is an indicator of how many ICD-10 codes are possible for the ICD-9 code, or how complex the ICD-9 to ICD-10 mapping is (e.g., when multiple ICD-10 codes are needed for an equivalent ICD-10 code). A “low-risk” code 204 is classified as an ICD-9 code that has a one-to-one relationship with a single ICD-10 code, that is, the ICD-9 code maps to a single ICD-10 code, and that ICD-10 code maps to the one ICD-9 code. Clearly, the risk for miscoding is low where there is only a single possible analog. A moderate risk code 206 is an ICD-9 code that only requires a single ICD-10 code for equivalence mapping, and which has multiple unique ICD-10 code analogs up to a predefined risk threshold, such as 10 or 11 total, or any other level defined by the user. This is “moderate risk” because with so few unique analogous ICD-10 codes, the risk that a user will not see or evaluate the appropriate ICD-10 code for the particular conversion is not very high. Lastly, a “high-risk” code 208 is an ICD-9 code that either requires multiple ICD-10 codes for an accurate diagnosis, or that exceeds the predefined risk threshold of ICD-10 code analogs. In such cases, the chances are greater that a user may simply miss the appropriate code analog among the numerous potential codes.

For moderate- and high-risk codes, the codes are parsed, sorted, and displayed, such as in a table, for facilitating a user's evaluation. To continue the example of the broken radius and ulna above, the original ICD-9 code, 813.44, presents a high-risk scenario, as it requires 2 ICD-10 codes for proper coding, and each list of analogous ICD-10 codes for coding includes at least 30 potential analogous codes. Accordingly, each ICD-9 code and its code mapping function are determined in step 200 to be a high risk scenario.

In step 210, each list of ICD-10 codes is parsed to identify subsets of codes having a common diagnosis (in this case, the type of fracture). For example, there are multiple codes that list a Barton's fracture of the radius: (1) S52.561A for a “Barton's fracture of the right radius, initial encounter for closed fracture,” (2) S52.562A for a “Barton's fracture of the left radius, initial encounter for closed fracture,” and (3) S52.569A for a “Barton's fracture of an unspecified radius, initial encounter for closed fracture.” Although these three separate codes are differentiated by which arm the fracture is located in (left, right, or unknown), they are all directed to the same injury type, a Barton's fracture and may be grouped together. Similarly, other subsets of fracture types are parsed.

In step 212, these subsets are sorted according to the definitional parameters. The definitional parameter may be an alphabetic listing of the diagnosis types according to which the subsets were parsed in step 210. Alternatively, other definitional parameter may be used. For example, the diagnoses may be sorted according to the most common diagnosis, such that very common diagnoses are sorted to the top, and uncommon or rare diagnoses are sorted to the bottom. The codes may also be sorted by numeric code order, by anatomy, by disease type, or other categories of information displayed by the codes.

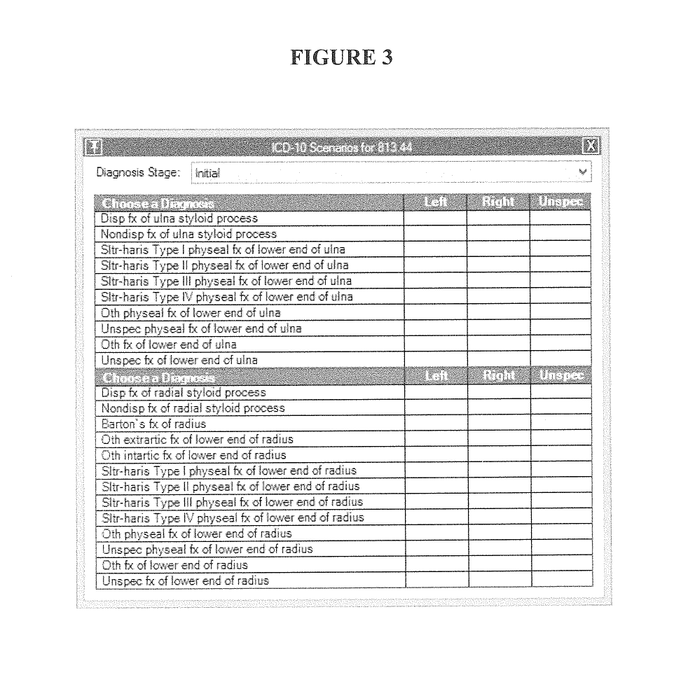

In step 214, the sorted lists are displayed. The result of the display is a custom scenario 216 that identifies the particular ICD-10 codes a user may select. An example of such a custom scenario is the chart 216 shown in FIG. 3. Each subset of the diagnosis is displayed on the left along a vertical axis, and the diagnosis location or laterality (left, right, unspecified) is provided along a horizontal axis on the right. FIG. 3 allows a user to quickly identify the type of fracture without wading through the all 414 diagnoses in an uncoordinated list. Selection of the intersection of a row (diagnosis subset) with column (laterality) will designate the corresponding ICD-10 code for that selection.

The steps of parsing, sorting, and displaying for each original ICD-9 code, or, if multiple substitute ICD-9 codes are being used, for each substitute ICD-9 code.

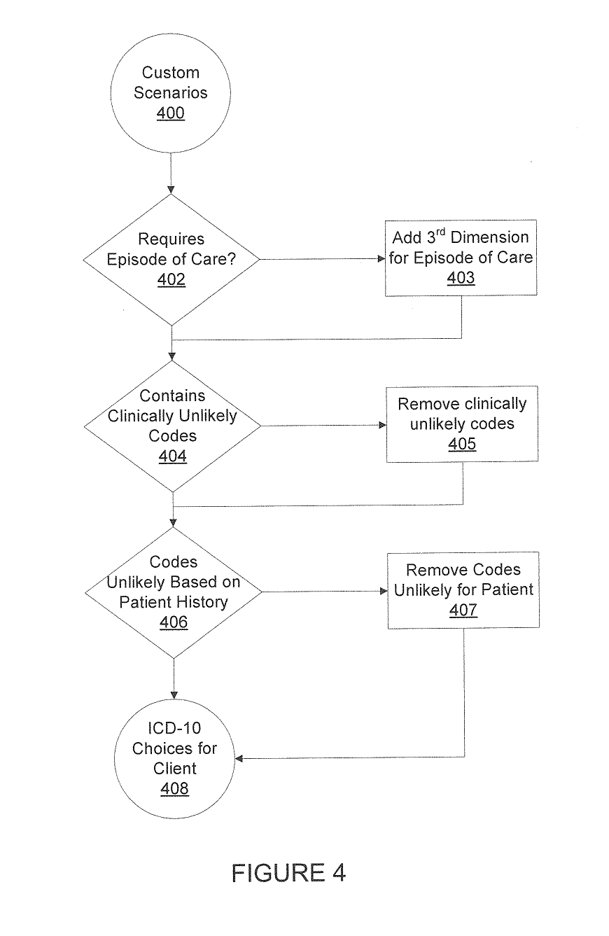

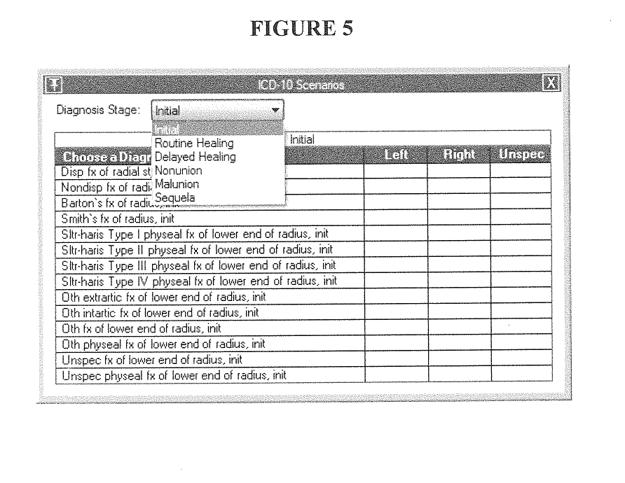

Once the full list of potential ICD-10 codes are displayed for the original or substitute ICD-9 codes, additional codes may be considered to address the diagnosis stage, or episode of care. This is shown in FIGS. 4 and 5. FIG. 4 depicts a flow chart for removing unlikely or irrelevant ICD-10 codes from the coder's review.

In step 402, a system identifies whether an episode of care is associated with the diagnosis. This may be the initial encounter, or a follow-up encounter. If it is a follow-up encounter, the user provides the stage to which the diagnosis has progressed. For example, in the case of the broken radius above, fracture may be showing routine healing, delayed healing, nonunion, malunion, or sequel conditions. These are shown in FIG. 5. The user may then select 403 the appropriate episode of care.

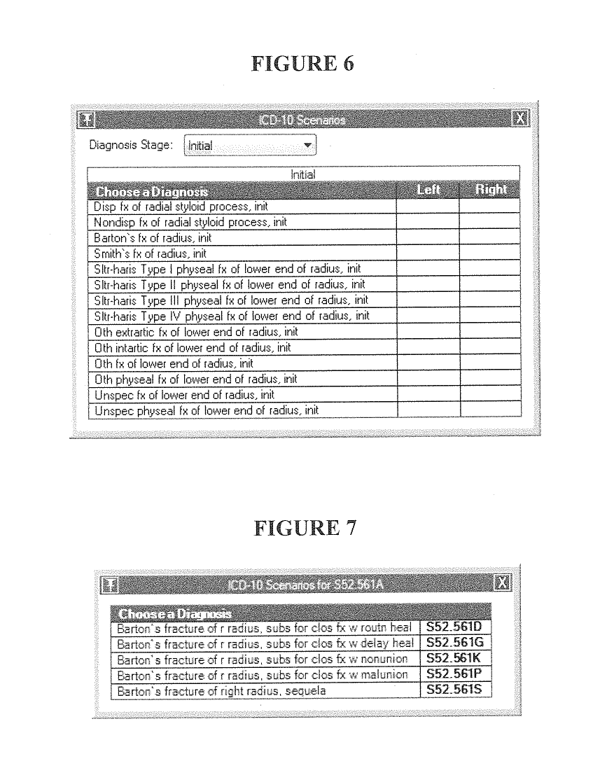

In step 404, the system removes clinically unlikely codes. For example, any code in which the laterality of the fracture is “unspecified” is clinically unlikely, as a treating physician will always be able to determine in which arm the fracture occurred. The purpose of having an “unspecified” code in ICD-10 is to accommodate conversions of historical ICD-9 code entries, which would not have identified the arm, in situations where the patient is no longer being regularly treated for that diagnosis. In such a case, there is no information available as to which arm was treated, and therefore it must remain unspecified. However, when the ICD-10 code is being entered for a new encounter, the arm will always be known. Therefore, the clinically unlikely codes identifying an “unspecified” arm can be removed from consideration. Other examples of clinically unlikely codes include unspecified fractures or unspecified encounters. FIG. 6 depicts a table with several clinically unlikely codes removed following step 405.

Lastly, codes may be identified 406 as being unlikely due to the patient's history, which are subsequently removed in step 407. For example, if the patient's prior medical history indicates that the patient was originally seen two weeks prior and diagnosed with a Barton's fracture of the right radius, the system can link this information and remove all other fracture codes, and the initial encounter code for a Barton's fracture, as shown in FIG. 7. Then, the user is left with simply a few potential codes. These codes may be ranked by a ranking factor. For example, they may be ranked according to commonality, alphabetical order, or otherwise. The prior medical history may reside within the previously coded data in the central database, be manually entered by the coder, or be accessed through the patient's electronic medical records.

The parsing, sorting, and removing steps may be further demonstrated by another example. As noted above, ICD-9 code 733.81 for “Malunion of Fracture” has over 2500 potential analogous ICD-10 codes. This is because ICD-9 code 733.81 does not specify the anatomical location of the fracture, the type of fracture or the laterality. Therefore, attempting to map “Malunion of Fracture” to an ICD-10 code will show every single fracture at each anatomical location, for each of left, right, or unspecified laterality. Therefore, the steps of parsing 210 and sorting 212 may not result in displaying the ICD-10 codes to coders in a useful format, simply because 2,500 potential codes would be overwhelming to review and consider. However, by removing clinically unlikely codes in step 405, hundreds of these codes may be cut simply by removing codes of “unspecified” laterality, fracture type, or anatomical location. Also, by taking into account a patient's prior medical history and then removing (or de-emphasizing, by moving down in the order) codes that are unlikely given that medical history in step 407, further refinement can be achieved in the list of potential ICD-10 codes. This is because the patient historical data will often provide a type of fracture, anatomical location and laterality. Thus, by taking into account the clinical likelihood of various diagnoses and a patient's medical history, the 2,500 potential ICD-10 codes for ICD-9 code 733.81 may be presented to the user as only a handful, or at most a few dozen, potential codes for conversion.

The display shown in FIG. 7 is one embodiment of the display to the user that results from the disclosed processes. The display is particularly important for providing the potential ICD-10 codes in an understandable fashion. Simply listing off any potential ICD-10 code identified in the mapping process will not provide the user much benefit, as the number of codes may be overwhelmingly long, as discussed above.

Because ICD-10 codes provide information related to a number of different concerns (laterality, episode of care, anatomical location, and medical diagnosis), which are referred to herein as definitional parameters, these parameters may be separated into and displayed along multiple axes. As shown in FIG. 5, each definitional parameter may be represented on its own axis in order to break down and sort the list of potential ICD-10 codes in a comprehensible fashion. As shown here, the rows may represent the potential diagnoses and anatomical locations that a user may select. Each row may have columns identifying the laterality as “left,” “right,” or “unspecified.” Finally, a third definitional parameter, the episode of care, may be selected from the drop-down menu provided at the top of the list. This drop-down menu, or similar selection interface (such as a series of radio buttons, check boxes, and the like), serves as an axis on which the third definitional parameter is displayed. In this way, all the parameters that define a related set of ICD-10 codes may be presented to the user in a manner that allows the user to obtain maximum benefit from the code mapping process. Other embodiments for the display are also possible. For example, the episode of care may be provided and the columns, and the laterality may be provided in the drop-down menu. Alternatively, two-dimensional tables may be “stacked” or tiled along a z axis, with the values of a third definitional parameter selected by picking the corresponding table.

As described above with respect to the example involving fractures, sets of ICD-10 codes may be identified based upon various definitional parameters such as injury type or episode of care. Within these sets, the codes may be further defined by parameters such as laterality, anatomical location, diagnosis, and episode of care, discussed above. There are many other definitional parameters that can be related dimensionally within ICD-10 to provide users a display for selecting a code. Other definitional parameters include fracture type, disease type, injury type, trimester (for pregnancy-related conditions), diagnosis stage or severity, disease stage, healing type, disease or condition onset or other time-based parameters, manifestations, comorbidites or complications, and etiology. These are the most commonly used definitional parameters. But other definitional parameters may be present or applicable to particular ICD-10 codes and may be selected as well for use in the database mapping and display choices.

The definitional parameters may be displayed using a 2- or 3-dimensional chart or graph. In a 2-dimensional chart, two definitional parameters may be related, for example, one on the chart x-axis (e.g., disease stage) and one on the chart y-axis (disease type). Some definitional parameters are particularly related, such that either they may typically be paired together, or they have overlapping or similar information charted therefore are not typically paired together and charted. For example fracture type, disease type, and injury type cover various types of maladies, separated out into different types (fracture, disease, or injury). Therefore, they may all be preferentially selected for showing on a single axis (e.g., the y-axis) because they will normally not be paired with each other (such that one would need to appear on the x-axis). Similarly laterality and anatomical location, fracture type and disease type; trimester and fetus; and disease type and disease stage cover distinct definitional parameters that are commonly used in combination with the other corresponding definitional parameter. Therefore, they may be preferentially selected for showing on a combination of multiple dimensions. For example, laterality will be on the x-axis and type of fracture on the y-axis.

This applied mapping process presents users with many benefits. For example, the user can identify many potential analogous ICD-10 codes for a possible ICD-9 code. The GEMs described above, for example, only present a single ICD-10 code for a single ICD-9 code, and vice versa. In contrast, the full range of potential codes available to a user for a single diagnosis may be presented through the process disclosed herein. Also, the process presents the codes in an efficient and intuitive manner. Rather than having to wade through numerous highly unlikely codes, the process focuses attention on the particular codes mostly likely to be of concern to the user. Alternatively, the codes can be provided in a chart form that allows the coding concepts of ICD-10 to be shown according to the multiple coding parameters that are coded in ICD-10 codes.

The process described here occurs on a computer processor, which has access to data storage containing the ICD-9 and ICD-10 databases and instructions for conducting the processes described here. Optionally, the processor may also have access to patient medical records to facilitate the removal of clinically unlikely codes and further narrow the range of options. The patient records may be maintained either in local data storage or remotely, in which case they can be accessed by a telecommunications network.

Although the present invention has been described and shown with reference to certain preferred embodiments thereof, other embodiments are possible. The foregoing description is therefore considered in all respects to be illustrative and not restrictive. Therefore, the present invention should be defined with reference to the claims and their equivalents, and the spirit and scope of the claims should not be limited to the description of the preferred embodiments contained herein.

What is claimed is:

1. A method of displaying ICD-10 code information to a user for facilitating a selection by said user of a particular ICD-10 code applicable to medical care provided to a patient, said method comprising:
displaying a set of ICD-9 codes;
receiving from the user a selection of one ICD-9 code from said ICD-9 code set;
associating said selected ICD-9 code with a set of ICD-10 codes, each code of said ICD-10 code set being defined by at least two definitional parameters;
displaying a set of the first definitional parameters on a first axis and a set of the second definitional parameter along a second axis; and
receiving from a user a selection of each definitional parameter thereby defining a particular ICD-10 code.

2. The method of claim 1, wherein each code of said set of ICD-10 codes is defined by a third definitional parameter and further comprising displaying said third definitional parameter on a third axis.

3. The method of claim 2, wherein first axis defines rows, said second axis defines columns, and said third axis defines subsets of said first and second definitional parameters displayed on rows and columns respectively, and said second receiving step comprises first receiving a selection of a third definitional parameter and then displaying the subset of said first and second definitional parameters corresponding to said selected third definitional parameter, and receiving a selection of each of said first and second definitional parameters from said displayed subset.

4. The method of claim 1, wherein first axis is vertical defining rows and said second axis is horizontal defining columns and said second receiving step comprises receiving a selection of a field that is the intersection of the row and column defining the selected ICD-10 code.

5. The method of claim 1, wherein said second receiving step comprises receiving a selection of a first definitional parameter from said first axis and a selection of a second definitional parameter from said second axis, thereby defining the selected ICD-10 code.

6. The method of claim 1, wherein said associating step comprises:
identifying at least one ICD-10 code in a database of ICD-10 codes to which the selected ICD-9 code maps, the at least one mapped ICD-10 code forming a forward map list;
identifying each ICD-10 code in the ICD-10 code database that backward maps to the selected ICD-9 code, the backwards mapped ICD-10 code forming a backward map list;
combining the forward map list and the backward map list to form a combined list; and
identifying each ICD-10 code appearing in the combined list; the identified codes being the set of ICD-10 codes.

7. The method of claim 6, further comprising:
removing clinically unlikely codes; and
removing codes having unspecified times of care;

8. The method of claim 6, further comprising retrieving historical diagnosis data for the patient indicative of whether or not the patient has received a related diagnosis within a predefined preceding time period, and if said patient does have a related diagnosis within said time period, removing codes based upon said related diagnosis.

9. The method of claim 1, wherein the least two definitional parameters are selected from the group consisting of: episode of care, diagnosis stage, disease stage, laterality, onset, complication, etiology, anatomical partsite, trimester, fetus, time frame, healing type, disease type, and injury type.

10. The method of claim 1, wherein the first definitional parameter is injury type, the second definitional parameter is laterality, and the third definitional parameter is episode of care.

11. The method of claim 1, wherein the first definitional parameter is anatomical part, the second definitional parameter is laterality, and the third definitional parameter is etiology.

12. The method of claim 1, wherein said first definitional parameter is disease type and said second definitional parameter is complications.

13. The method of claim 1, wherein said first definitional parameter is disease stage and said second definitional parameter is laterality.

14. The method of claim 1, wherein the first definitional parameter is selected from the group consisting of fracture type, disease type, injury type, and trimester, and the second definitional parameter is selected from the group consisting of laterality, disease stage, anatomical location, and fetus.

15. The method of claim 14, wherein each code of said set of ICD-10 codes is defined by a third definitional parameter and further comprising displaying said third definitional parameter on a third axis, said third definitional parameter being episode of care.

16. The method of claim 2, wherein the third definitional parameter is episode of care, and further comprising retrieving historical diagnosis data for the patient indicative of whether or not the patient has received a related diagnosis within a predefined preceding time period, and if said patient does not have a related diagnosis within said time period, defaulting said episode of care to an initial episode of care, and if said patient does have a related diagnosis within said time period, defining said third definitional value to an episode of care subsequent to an episode of care associated with the most recent medical care indicated by said related diagnosis.

17. The method of claim 13, further comprising displaying a subset of first and second definitional parameters corresponding to said defined third definitional value.

18. A method for creating a relevant list of applicable medical code entries in a second database that may apply to a particular patient, the applicable medical code entries each corresponding to a medical code entry in a first database, where the second database has more code entries than the first database, comprising:
identifying at least one medical code entry in the second database to which the medical code entry in the first database maps, the medical code entries in the second database forming a forward map list;
identifying each medical code entry in the second database that backward maps to the medical code entry in the first database, the medical code entries in the second database forming a backward map list;
combining the forward map list and the backward map list to form a combined list;
identifying each code appearing in the combined list;
removing clinically unlikely codes; and
removing codes having unspecified times of care.

19. The method of claim 18, further comprising retrieving historical diagnosis data for the patient indicative of whether or not the patient has received a related diagnosis within a predefined preceding time period, and if said patient does have a related diagnosis within said time period, removing codes based upon said related diagnosis.

20. The method of claim 18, further comprising ranking the codes in the combined list based upon commonality.
